(19) United States
(12) Patent Application Publication
(10) Pub. No.: US 2023/0033096 A1
(43) Pub. Date: Feb. 2, 2023

(54) SYSTEMS AND METHODS FOR SUPPORTING MULTI-USIM USER EQUIPMENT

(71) Applicant: SHARP KABUSHIKI KAISHA, Sakai City, Osaka (JP)

(72) Inventor: Kamel M. SHAHEEN, Vancouver, WA (US)

(21) Appl. No.: 17/911,950

(22) PCT Filed: Feb. 3, 2021
(86) PCT No.: PCT/JP2021/003942

§ 371 Date: Sep. 15, 2022

Related U.S. Application Data
(60) Provisional application No. 62/992,373, filed on Mar. 20, 2020.

(51) Int. Cl. H04W 8/18; H04W 68/00; H04W 24/08

(52) U.S. Cl. CPC H04W 8/183; H04W 68/005; H04W 24/08

(57) ABSTRACT

A user equipment (UE) for wireless communication includes one or more non-transitory computer-readable media having computer-executable instructions embodied thereon, at least one processor coupled to the one or more non-transitory computer-readable media and configured to execute the computer-executable instructions to: detect a presence of multiple-universal subscriber identity module (multi-USIM) based operations having at least a first USIM based operation and a second USIM based operation in the UE, receive paging resource configurations for the first USIM and the second USIM, and monitor at least one paging resource channel indicated in the paging resource configurations for receiving paging for at least one of the first USIM and the second USIM.

### CROSS REFERENCE

This Nonprovisional application claims priority under 35 U.S.C. § 119 on provisional Application No. 62/992,373 on Mar. 20, 2020, the entire contents of which are hereby incorporated by reference.

### TECHNICAL FIELD

The present disclosure generally relates to wireless communication, and more particularly, to systems and methods for supporting multiple-universal subscriber identity module (multi-USIM) based operations in a user equipment (UE) supporting same or different operators.

### BACKGROUND ART

In wireless communication systems, support for multi-USIM based operations in a UE is handled in an implementation-specific manner without any support from 3rd Generation Partnership Project (3GPP) specifications, resulting in a variety of implementations and UE behaviors. In a multi-USIM device, the USIMs typically share common radio and baseband components. Thus, the multi-USIM device may register in different networks but using one radio front-end (RF) and base band.

In the next generation (e.g., fifth generation (5G) new radio (NR) wireless communication networks, a multi-USIM UE is expected to be in Radio Resource Control (RRC) Connected state with only one network at a time, while being able to receive paging, perform signal measurements, or read system information, and determine if it needs to respond to paging requests from other networks. With a single RF plate-form, however, the UE must listen to paging of the other connection(s), and the network needs to be aware of the multi-registration scenario. When a UE is paged on a second system while connected to a first system, the paged UE may drop the connection on the first system and attempt to access the second system without releasing the first connection due to lack of time to switch systems. Such behaviors can cause performance degradations and reductions in overall system capacity.

On the network end, the current network systems remain ignorant of the UEs' capability to support multi-USIM based operations. In order to support multi-USIM UEs, the network systems need to be aware of such capabilities in order to coordinate the operations of multi-USIM registrations, potential simultaneous operations and collision avoidance.

Thus, there is a need in the art for multi-USIM based operation UE and multi-network coordination.

### SUMMARY OF INVENTION

In one example, a user equipment (UE) for wireless communication, the UE comprising: one or more non-transitory computer-readable media having computer-executable instructions embodied thereon; at least one processor coupled to the one or more non-transitory computer-readable media and configured to execute the computer-executable instructions to: detect a presence of multiple-universal subscriber identity module (multi-USIM) based operations having at least a first USIM based operation and a second USIM based operation in the UE; receive paging resource configurations for the first USIM and the second USIM; monitor at least one paging resource channel indicated in the paging resource configurations for receiving paging for at least one of the first USIM and the second USIM.

In one example, a method of a user equipment (UE), the method comprising: detecting a presence of multi-multiple-universal subscriber identity module (multi-USIM) based operations having at least a first USIM based operation and a second USIM based operation in the UE; receiving paging resource configurations for the first USIM and the second USIM; monitoring at least one paging resource channel indicated in the paging resource configurations for receiving paging for at least one of the first USIM and the second USIM.

In one example, a communication network comprising: a Public Land Mobile Network (PLMN) configured to: receive a first registration message in a first multiple-universal subscriber identity module (USIM) based operation of a user equipment (UE), the first registration message comprising an indication of a presence of multi-USIM based operations in the UE; send paging resource configurations to the UE; wherein the paging resource configurations comprise at least one paging resource channel for paging at least one of a first USIM and a second USIM of the UE.

In one example, a method of a communication network, the method comprising: receiving, by a Public Land Mobile Network (PLMN), a first registration message in a first multiple-universal subscriber identity module (USIM) based operation of a user equipment (UE), the first registration message comprising an indication of a presence of multi-USIM based operations in the UE; sending, by the PLMN, paging resource configurations to the UE; wherein the paging resource configurations comprise at least one paging resource channel for paging at least one of a first USIM and a second USIM of the UE.

### BRIEF DESCRIPTION OF DRAWINGS

Implementations of the present technology will now be described, by way of example only, with reference to the attached figures.

FIG. 1 is a block diagram of a multi-USIM UE supporting same or different operators, in accordance with various example implementations of the present disclosure.

FIG. 2 is a flowchart diagram illustrating a method of a UE for performing multi-USIM registrations in same or different communication networks, in accordance with example implementations of the present disclosure.

FIG. 3 is a signaling sequence diagram for schematically illustrating a method of registering the presence of multi-USIM based operations in a UE and capabilities of the multi-USIM based operations belonging to same or different wireless communication networks, and paging the multi-USIM based operation UE based on paging resource configurations from the networks, in accordance with example implementations of the present disclosure.

FIG. 4A is a flowchart diagram illustrating a method of a multi-USIM based operation UE for multi-USIM registrations in multiple wireless communication networks and receiving paging based on paging resource configurations from the networks, in accordance with example implementations of the present disclosure.

FIG. 4B is a flowchart diagram illustrating a method of a plurality of wireless communication networks for registering a multi-USIM based operation UE and providing paging based on paging resource configurations to the multi-USIM based operation UE, in accordance with example implementations of the present disclosure.

FIG. 5 is a signaling sequence diagram for schematically illustrating a method of registering the presence of multi-USIM based operations in a UE and capabilities of the multi-USIM based operations belonging to same or different wireless communication networks, and paging the multi-USIM based operation UE based on paging resource configurations from the networks, in accordance with example implementations of the present disclosure.

FIG. 6A is a flowchart diagram illustrating a method of a multi-USIM based operation UE for multi-USIM registrations in multiple wireless communication networks and receiving paging based on paging resource configurations from the networks, in accordance with example implementations of the present disclosure.

FIG. 6B is a flowchart diagram illustrating a method of a plurality of wireless communication networks for registering a multi-USIM based operation UE and providing paging based on paging resource configurations to the multi-USIM based operation UE, in accordance with example implementations of the present disclosure.

FIG. 7 is a signaling sequence diagram for schematically illustrating a method of registering the presence of multi-USIM based operations in a UE and capabilities of the multi-USIM based operations belonging to different wireless communication networks, and paging the multi-USIM based operation UE based on paging resource configurations from the networks, in accordance with example implementations of the present disclosure.

### DESCRIPTION OF EMBODIMENTS

The 3GPP is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access network system (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12, 13, 14 and/or 15) including New Radio (NR) which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In the 3GPP specifications, a base station is typically referred to as a Node B, an evolved Node B (eNB), a home enhanced or evolved Node B (HeNB), a next Generation Node B (gNB) or some other similar terminology. As the scope of the disclosure should not be limited to 3GPP standards, the terms “base station,” “Node B,” “eNB,” “HeNB,” and “gNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra-Reliable and Low Latency Communication) transmission, and eMTC (massive Machine Type Communication) transmission. Also, in NR, single-beam and/or multi-beam operations is considered for downlink and/or uplink transmissions.

In order for the services to use the time/frequency/space resource efficiently, it would be useful to be able to efficiently control uplink transmissions. Therefore, a procedure for efficient control of uplink transmissions should be designed. However, the detailed design of a procedure for uplink transmissions has not been studied yet.

According to the systems and methods described herein, a UE may transmit multiple reference signals (RSs) associated with one or more Transmission Reception Points (TRPs) on a UL antenna port. For example, multiple UL RSs respectively associated with one or more TRPs may be transmitted on a UL antenna port. Namely, there may be one or more UL RSs transmitted per UL antenna port. Also, there may be one or more UL RSs transmitted per TRP.

In an example, one TRP may be associated with one UL antenna port. In another example, one TRP may be associated with multiple UL antenna port(s). In another example, multiple TRP(s) may be associated with multiple UL antenna port(s). In yet another example multiple antenna port(s) may be associated with one UL antenna port. The TRP(s) described herein are assumed to be included in the antenna port(s) for the sake of simple description.

Here, for example, multiple UL RSs transmitted on an UL antenna port may be defined by a same sequence (e.g., a demodulation reference signal sequence, and/or a reference signal sequence). For example, the same sequence may be generated based on a first parameter configured by a higher layer. The first parameter may be associated with a cyclic shift, and/or information associated with a beam index.

Or, multiple UL RSs transmitted on an UL antenna port may be identified by a different sequence. Each of the different signal sequence may be generated based on each of more than one second parameter(s) configured by a higher layer. One second parameter among more than one second parameters may be indicated by DCI. Each of the second parameters may be associated with a cyclic shift, and/or information associated with a beam index.

Also, resource element(s) to which multiple UL RSs transmitted on a UL antenna port are mapped may be defined by the same value of a frequency shift. For example, the same value of the frequency shift may be given by a third parameter configured by a higher layer. The third information may be associated with a beam index.

Alternatively, resource element(s) to which multiple UL RSs transmitted on a UL antenna port are mapped may be identified by different values of a frequency shift. Each of the different values of the frequency shift may be given by each of more than one fourth parameter(s) configured by a higher layer. One fourth parameter among more than one parameters may be indicated by DCI. Each of the fourth parameters may be associated with a beam index.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

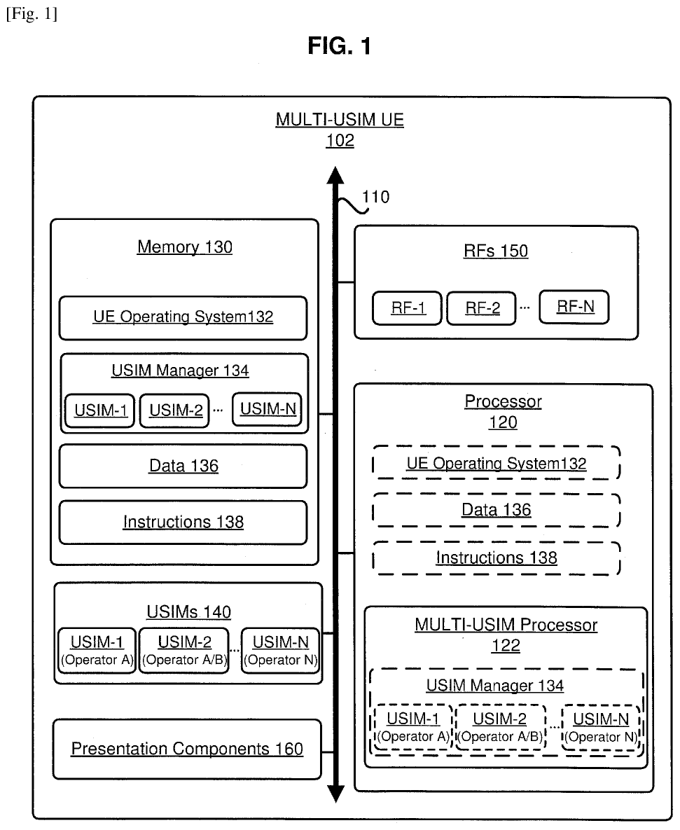

FIG. 1 is a block diagram of a multi-USIM UE supporting different operators, in accordance with various example implementations of the present disclosure. As shown in FIG. 1, multi-USIM UE 102 may include processor 120, memory 130, multiple USIMs 140 belonging to different networks/operators, multiple Radio Front-end circuitries (RFs) 150, and one or more presentation components 160. Multi-USIM UE 102 may also include one or more radio frequency spectrum band modules, one or more base station communications modules, one or more network communications modules, and one or more system communications management modules, Input/Output (I/O) ports, I/O components, and power supply (not explicitly shown in FIG. 1). Each of these components may be in communication with each other, directly or indirectly, over one or more buses 110.

In various implementations of the present disclosure, processor 120 (e.g., having processing circuitry) may include an intelligent hardware device, e.g., a Central Processing Unit (CPU), a microcontroller, an ASIC, and etc. Processor 120 may also include memory storage. As illustrated in FIG. 1, processor 120 may be responsible for running UE operating system 132, and processing data 136 and instructions 138 received from memory 130, information through RFs 150, the base band communications module, and/or the network communications module. Processor 120 may also process information to be sent to RFs 150 for transmission to the network communications module for transmission to a core network. In the present implementation, processor 120 may include multi-USIM processor 122 for processing instructions from USIM manager 134 for one or more of USIMs of multi-USIM UE 102, for example.

As illustrated in FIG. 1, memory 130 may store UE operating system 132, USIM manager 134, data 136, and computer-readable, computer-executable instructions 138 (e.g., software codes) that are configured to, when executed, cause processor 120 to perform various functions described herein. Alternatively, USIM manager 134 and/or instructions 138 may not be directly executable by processor 120 but be configured to cause multi-USIM UE 102 (e.g., when compiled and executed) to perform various functions described herein.

In various implementation of the present disclosure, memory 130 may include a variety of computer-readable media. Computer-readable media may be any available media that may be accessed by multi-USIM UE 102 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, Digital Versatile Disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. In various implementation of the present disclosure, memory 130 may include computer-storage media in the form of volatile and/or non-volatile memory. Memory 130 may be removable, non-removable, or a combination thereof. Example memory includes solid-state memory, hard drives, optical-disc drives, and etc.

As illustrated in FIG. 1, multi-USIM UE 102 may include multiple USIMs 140, such as USIM-1, USIM-2, through USIM-N. USIM-1, USIM-2, through USIM-N may belong to a same or different networks/operators (e.g., Public Land Mobile Network (PLMN)). For example, USIM-1, USIM-2, through USIM-N may belong to Operator A, Operator B, through Operator N, respectively. It should be noted that, although USIMs are described in the present implementation and various implementations of the present disclosure, other subscriber identity modules or subscriber identification modules (e.g., SIMs) can also be used.

As shown in FIG. 1, multi-USIM UE 102 may include multiple RFs 150, such as RF-1, RF-2, through RF-N. Each of the RFs 150 may include a transmitter (e.g., transmitting/transmission circuitry) and a receiver (e.g., receiving/reception circuitry). In some implementations of present disclosure, RF-1, RF-2, through RF-N of RFs 150 may respectively correspond to USIM-1, USIM-2, through USIM-N, where USIM-1, USIM-2, through USIM-N may transmit and/or receive data and control channels, for example, through RF-1, RF-2, through RF-N, respectively. In some implementations of the present disclosure, RFs 150 may include shared RF circuitry for multi-USIM based operations. For example, the UE may need to switch among USIM-1, USIM-2, through USIM-N to share the RF circuitry for transmitting and/or receiving data and control channels. In some implementations, only one USIM may utilize the shared RF circuitry at any given time.

As shown in FIG. 1, multi-USIM UE 102 may include presentation components 160 for presenting data indications to a person or other device. Examples of presentation components 160 may include a display device, speaker, printing component, vibrating component, etc.

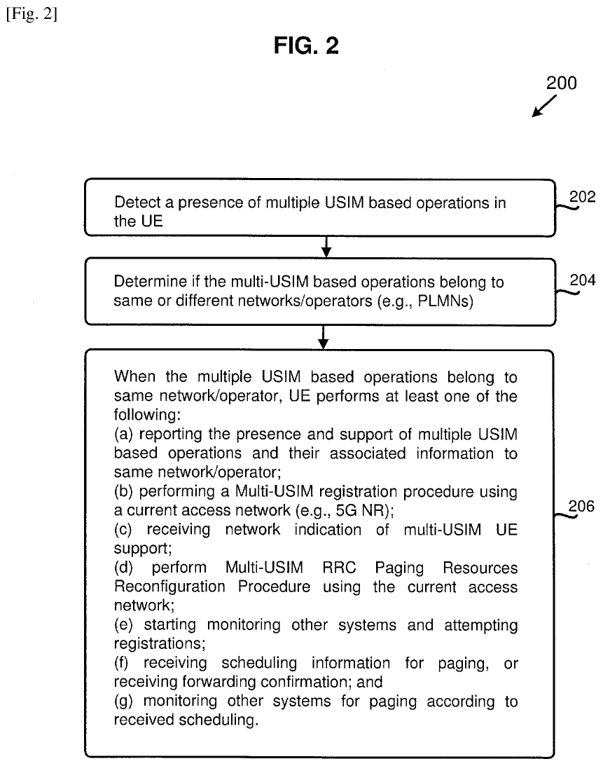

FIG. 2 is a flowchart diagram illustrating a method of a UE for performing multi-USIM registrations in same or different communication networks, in accordance with example implementations of the present disclosure. As illustrated in FIG. 2, flowchart 200 may include actions 202, 204, and 206. In one implementation, the UE described in flowchart 200 may correspond to multi-USIM UE 102 in FIG. 1.

In action 202, the UE may detect a presence of multiple USIM based operations in the UE. In one implementation, before the UE is powered on, two or more USIMs are inserted into the USIM card slots of the UE, for example. When the UE is powered on, the UE (e.g., through multi-USIM processor 122 and USIM manager 134 in FIG. 1) may detect the presence of the multiple USIM based operations. In another implementation, the UE is initially powered on with a first USIM based operation, and a second USIM based operation is later inserted into the UE. The UE (e.g., through multi-USIM processor 122 and USIM manager 134 in FIG. 1) may detect the second USIM based operation while the UE is operating with the first USIM based operation already registered with the current network.

In action 204, the UE may determine if the multi-USIM based operations belong to the same or different networks/operators. In one implementation, the UE may check the operator IDs (e.g., PLMN IDs) associated with the USIM based operations in the UE to determine if the multi-USIM based operations belong to different networks/operators. For example, when the PLUM IDs of the USIM based operations are different, then the multiple USIM based operations belong to different networks/operators.

In action 206, when the multi-USIM based operations belong to the same network/operator, the UE may report the presence and support of multi-USIM based operations and their associated information to the network/operator. The UE may perform a Multi-USIM registration procedure using a current access network (e.g., 5G NR network). The UE may receive a network indication of multi-USIM UE support. The UE may perform a multi-USIM RRC paging resources reconfiguration procedure using the current access network. The UE may start monitor other systems and attempt registrations. The UE may receive scheduling information for paging or receiving forwarding confirmation. The UE may also monitor other systems for paging according to received scheduling.

In one or more implementations of the present disclosure, when the multi-USIM based operations belong to different networks/operators, the UE may report the presence and support of multi-USIM based operations and their associated information to the networks/operators. The UE may perform a single USIM registration procedure using a current (or preferred) access network (e.g., 5G NR). The UE may receive a network indication of multi-USIM and multi-access/operator (e.g., PLMN) UE support. The UE may start monitor other systems and attempt registrations. The UE may receive scheduling information for paging or receiving forwarding confirmation. The UE may also monitor other systems for paging according to received scheduling.

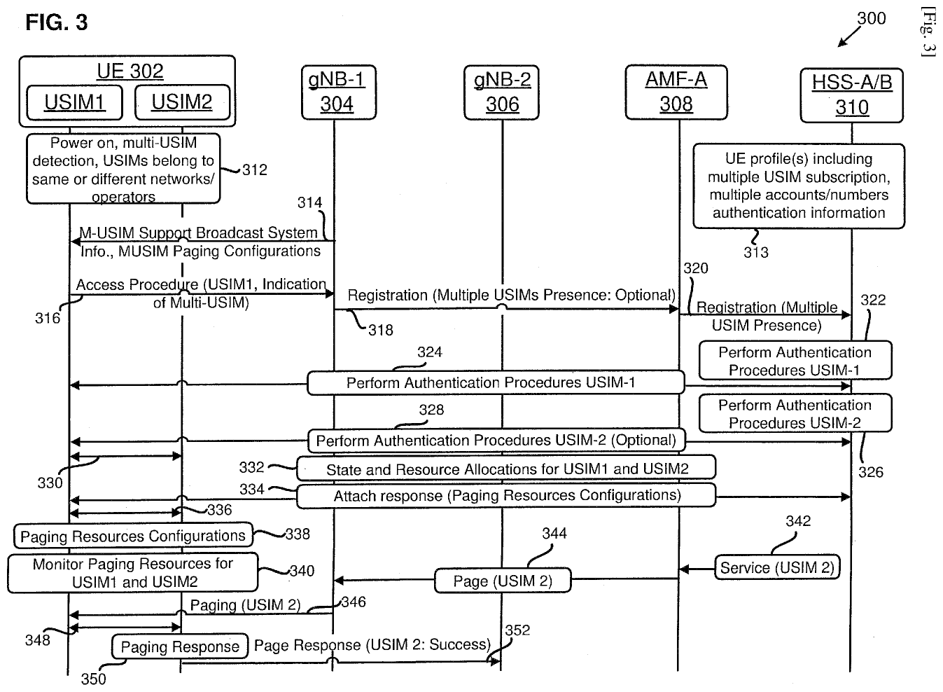

FIG. 3 is a signaling sequence diagram for schematically illustrating a method of registering the presence of multi-USIM based operations in a UE and capabilities of the multi-USIM based operations belonging to same or different wireless communication networks, and paging the multi-USIM based operation UE based on paging resource configurations from the networks, in accordance with example implementations of the present disclosure.

As shown in FIG. 3, in diagram 300, UE 302 may report or register the presence and capabilities of multi-USIM based operations to Mobility Management Function (AMF) 308 and Home Subscriber Server (HSS, A or B) 310 respectively through gNB-1 304 and gNB-2 306, for example, through one or more of actions 312, 313, 314, 316, 318, 320, 322, 324, 326, 328, 330, 332, 334, 336, 338, 340, 342, 344, 346, 348, 350, and 352. In one implementation, UE 302 described in diagram 300 may correspond to multi-USIM UE 102 in FIG. 1. It should be noted that, in diagram 300, although UE 302 is shown to include two USIM based operations (USIM1 and USIM2 based operations), UE 302 may include and support more than two USIM based operations.

In action 312, UE 302 may be powered on. For example, UE 302 is turned on by a user. UE 302 may detect a presence of multiple USIMs, and multi-USIM based operations. For example, when UE 302 is powered on, UE 302 (e.g., through multi-USIM processor 122 and USIM manager 134 in FIG. 1) may detect the presence of more than one USIM. In the present implementation, before UE 302 is powered on, USIM1 and USIM2 are inserted into the USIM card slots of UE 302, for example. Thus, upon being powered on, UE 302 detects the presence of both USIM and USIM2 based operations. UE 302 may further determine if USIM1 and USIM2 based operations belong to same or different networks/operators (e.g., gNB-1 304 and gNB-2 306 in FIG. 3). In one implementation, UE 302 may check the operator IDs (e.g., PLMN IDs) associated with USIM1 and USIM2 based operations to determine if the operator IDs are different. For example, each operator ID may include a mobile country code (MCC) and a mobile network code (MNC). When the MCC and MNC of USIM1 based operations do not match those of USIM2 based operations, then UE 302 determines that USIM1 based operations and USIM2 based operations respectively belong to different networks/operators (e.g., gNB-1 304 (first PLMN) and gNB-2 306 (second PLMN)). In another implementation, UE 302 may check the operator IDs (e.g., PLMN IDs) associated with USIM1 and USIM2 based operations to determine if the operator IDs are same. For example, each operator ID may include a mobile country code (MCC) and a mobile network code (MNC). When the MCC and MNC of USIM1 based operations match those of USIM2 based operations, then UE 302 determines that USIM1 based operations and USIM2 based operations respectively belong to the same network/operator (e.g., PLMN).

In action 313, HSS-AB 310 may store UE profiles including multi-USIM subscriptions, multiple accounts/numbers authentication information for one or more UEs.

In action 314, gNB-1 304 may send a Multi-USIM (M-USIM) paging configuration message to USIM1 of UE 302. The M-USIM paging configuration message may contain a block allocated for common paging resources for the M-USIM UE 302 to reduce the time necessary for UE 302 to scan and find individual paging resources based on its ID. In one implementation, the M-USIM paging configuration message may be included in M-USIM support broadcast system information.

In action 316, UE 302 may initiate an access procedure with gNB-1 304 using USIM1. In the access procedure, UE 302 may send a message to gNB-1 304 using USIM1, the associated RF circuitry (e.g., RF1 in FIG. 1), and the current access network system of USIM1. The message may include an indication indicating the presence of USIM1 and USIM2 in UE 302, and USIM2 related information (e.g., phone number, IMSI, IMEI, TMSI, etc.). The message may also include updated capabilities of USIM1.

In action 318, gNB-1 304 may send a registration message to AMF-A 308, for example, to register USIM1 of UE 302. The message may optionally include the multi-USIM presence of USIM1 and USIM2.

In action 320, AMF-A 308 may send the registration message having the multi-USIM presence of USIM1 and USIM2 to HSS-A/B 310 through the registration procedure.

In action 322, HSS-AB 310 may initiate authentication procedures for USIM1. In action 324, HSS-AB 310 and UE 302 may perform the authentication procedures for USIM1.

In action 326, HSS-AB 310 may initiate authentication procedures of USIM2. In action 328, HSS-AB 310 and UE 302 may perform the authentication procedures for USIM2 via the USIM1 based operations. In one implementation, actions 326 and 328 may be optional.

In action 330, USIM2 may communicate with USIM1 (e.g., through USIM manager 134 in FIG. 1) to inform each other that both USIM1 that USIM2 are successfully authenticated and registered with their respective gNB-1 304 and gNB-2 306.

In action 332, gNB-1 304, gNB-2 306, and AMF-A 308 may determine the state and resource allocations for USIM1 and USIM2.

In action 334, HSS-AB 310 may send an attachment response to USIM1 of UE 302 in an attachment response procedure. In one implementation, the response may include additional information regarding UE 302 including IDs that can be used to determine paging resources in gNB-1 304 and gNB-2 306, and/or additional information regarding the common paging resources for M-USIM UE 302. During the attachment procedure, UE 302 may be in an RRC connected state with gNB-1 304. After the attachment procedure, UE 302 may reconfigure the RRC state to adjust for any anticipated traffic.

In action 336, USIM 1 may forward the attach response to USIM 2.

In action 338, USIM1 may communicate with USIM2 to inform USIM2 of the attachment response including the additional information regarding the paging resources for USIM1 and USIM2 with their associated gNB-1 304 and gNB-2 306 respective.

In action 340, UE 302 may begin to monitor paging resources (e.g., channels) for USIM1 and USIM2 using the common paging resources on gNB-1 304 or may determine if a different block in the attachment procedure is allocated to UE 302. In one implementation, UE 302 may monitor the paging channel dedicated to USIM1 and the common paging channel for USIM2 paging. In another implementation, UE 302 may switch between USIM1 and USIM2 to use the shared RF circuitry to monitor their assigned paging resources based on the paging resource configurations.

In action 342, AMF-A 308 may receive a service request for USIM2.

In action 344, AMF-A 308 may send a paging message regarding the service request for USIM2 to gNB-1 304.

In action 346, gNB-1 304 may forward the paging message regarding the service request for USIM2 to USIM1.

In action 348, USIM1 may forward the paging message regarding the service request to USIM2. In one implementation, when UE 302 receives the paging message in action 346, UE 302 is operating on USIM1 mode and receiving the paging message distant for USIM-2 on gNB-1 304 air interface. UE 302 receives the paging message and recognizes that it is for USIM-2, then forwards the paging message to USIM-2 state machine which prepares an air interface to gNB-2 306 and sends a paging response in action 350.

In action 350, USIM2 may initiate a paging response to reply the service request for USIM2 by preparing an air interface to gNB-2 306. In one implementation, UE 302 may establish a new RRC connection (e.g. prepare an air interface) with gNB-2 306 if no RRC connection has already been established with gNB-2 306. This may be referred to as RRC state allocation between USIM1 and USIM2 in UE 302.

In action 352, USIM2 may send the page response to gNB-2 306, which confirms or denies the service request with gNB-2 306.

It should be noted that during the registration procedures for the multi-USIM based operations, authentication procedures may also be implemented and the success of authentication for the multi-USIM based operations belonging to the multi-PLMNs may also be necessary to complete the registration of the multi-USIM based operations. The details of the authentication procedures are omitted for brevity.

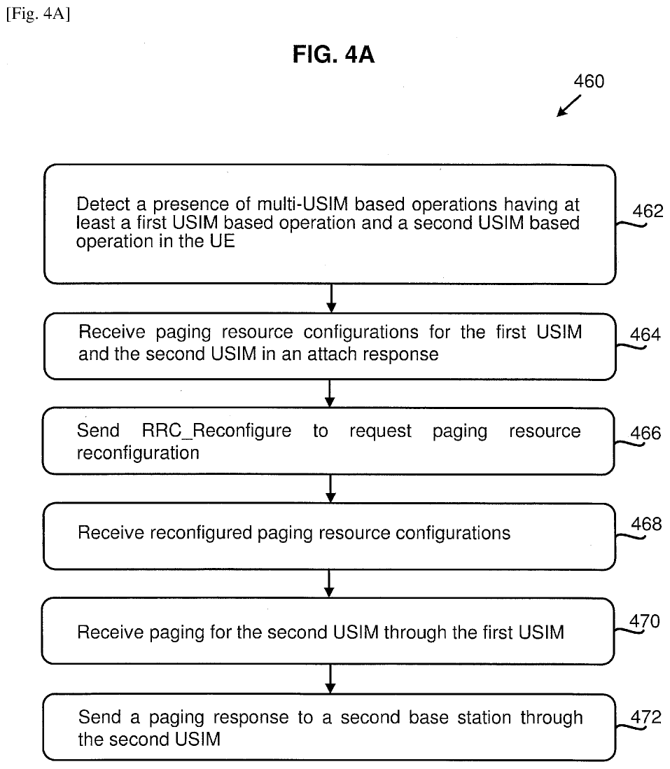

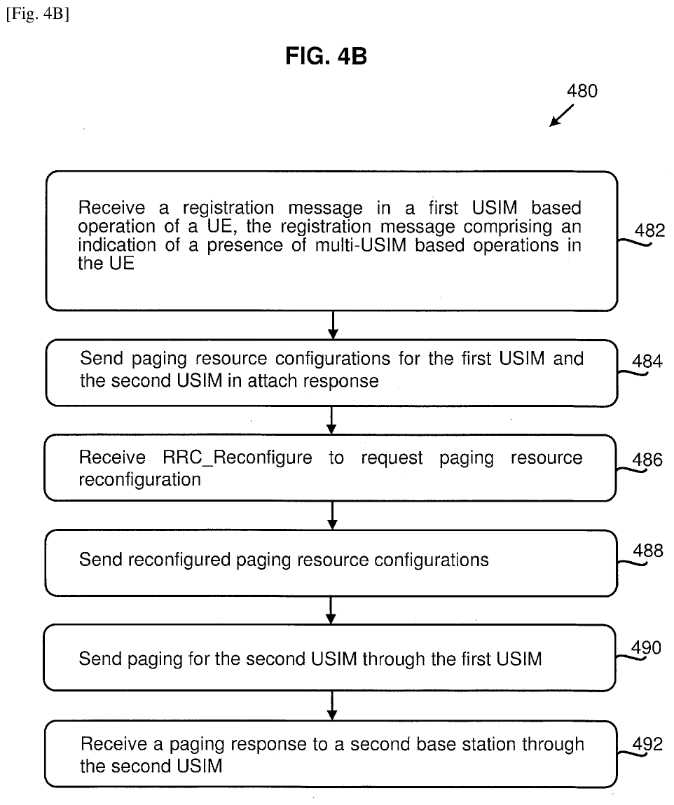

FIG. 4A is a flowchart diagram illustrating a method of a multi-USIM based operation UE for multi-USIM registrations in multiple wireless communication networks and receiving paging based on paging resource configurations from the networks, in accordance with example implementations of the present disclosure. As illustrated in FIG. 4A, flowchart 460 may include actions 462, 464, 466, 468, 470, and 472. In the present implementation, the UE may correspond to UE 302 supporting multi-USIM based operations in FIG. 3. Actions 462, 464, 466, 468, 470, and 472 will be discussed with reference to FIG. 3 below.

In action 462, the UE may detect a presence of multiple USIM based operations in the UE. For example, in FIG. 3, before UE 302 is powered on, USIM1 and USIM2 are inserted into the USIM card slots of UE 302, for example. When UE 302 is powered on, UE 302 (e.g., through multi-USIM processor 122 and USIM manager 134 in FIG. 1) may detect the presence of USIM1 and USIM2 based operations (e.g., action 312 in FIG. 3). UE 302 may further determine whether USIM1 and USIM2 based operations belong to the same or different networks/operators, for example, by comparing the operator IDs (e.g., PLMN IDs) of USIM1 and USIM2 based operations (e.g., action 312 in FIG. 3).

In action 464, the UE may receive paging resource configurations for the first USIM and the second USIM in an attach response. The paging resource configurations may include paging resource allocations for one or more USIMs of the UE. For example, in FIG. 3, USIM1 of UE 302 may receive an attach response in an attachment procedure from HSS-A/B 310 in action 334. In one implementation, the response may include additional information regarding UE 302 including IDs that can be used to determine paging resources in gNB-1 304 and gNB-2 306, and/or additional information regarding the common paging resources for M-USIM UE 302. During the attachment procedure, UE 302 may be in an RRC connected state with gNB-1 304. At the end of the attachment procedure, UE 302 may reconfigure its RRC state to adjust for any anticipated traffic.

In action 466, the UE may, optionally, send an RRC reconfiguration message to its serving base station to request to reconfigure the paging resources.

In action 468, the UE may, optionally, receive reconfigured paging resource configurations.

In action 470, the UE may receive paging for a second USIM through the first USIM. For example, in FIG. 3, in actions 342 through 348, UE 302 may receive paging for USIM2 from AMF-A 308 through USIM1 based on a service call for USIM2.

In action 472, the UE may send a paging response to an associated base station through the second USIM. For example, in FIG. 3, in action 352, UE 302 may send a paging response to gNB-2 306 using USIM2.

FIG. 4B is a flowchart diagram illustrating a method of a plurality of wireless communication networks for registering a multi-USIM based operation UE and providing paging based on paging resource configurations to the multi-USIM based operation UE, in accordance with example implementations of the present disclosure. As illustrated in FIG. 4B, flowchart 480 may include actions 482, 484, 486, 488, 490, and 492. In the present implementation, the network may include, but is not limited to, gNB-1 304, gNB-2 306, AMF-A 308, and HSS-A/B 310 in FIG. 3. Actions 482, 484, 486, 488, 490, and 492 will be discussed with reference to FIG. 3 below.

In action 482, the network may receive a registration message in a first MUSIM based operation of the UE, where the registration message includes an indication of the presence of M-USIM based operations in the UE. For example, in FIG. 3, after UE 302 determines that USIM1 and USIM2 based operations belong to same or different networks/operators, gNB-1 304 may receive a registration message from USIM1 in action 316.

In action 484, the network may send paging resource configurations for the first USIM and the second USIM in an attach response. For example, in FIG. 3, HSS-A/B 310 may send an attach response in an attachment procedure to USIM1 of UE 302 in action 334.

In action 486, the network may receive an RRC reconfiguration message from UE to reconfigure paging resources. In one implementation, action 486 may be optional.

In action 488, the network may send reconfigured paging resource configurations to UE. In one implementation, action 488 may be optional.

In action 490, the network may send a paging message for a second USIM through the first USIM. For example, in actions 342 through 346, AMF-A 308 may send a paging message for USIM2 to USIM1 through gNB-1 304.

In action 492, the network may receive a paging response from the second USIM. For example, in action 352, gNB-2 306 may receive a paging response from USIM2.

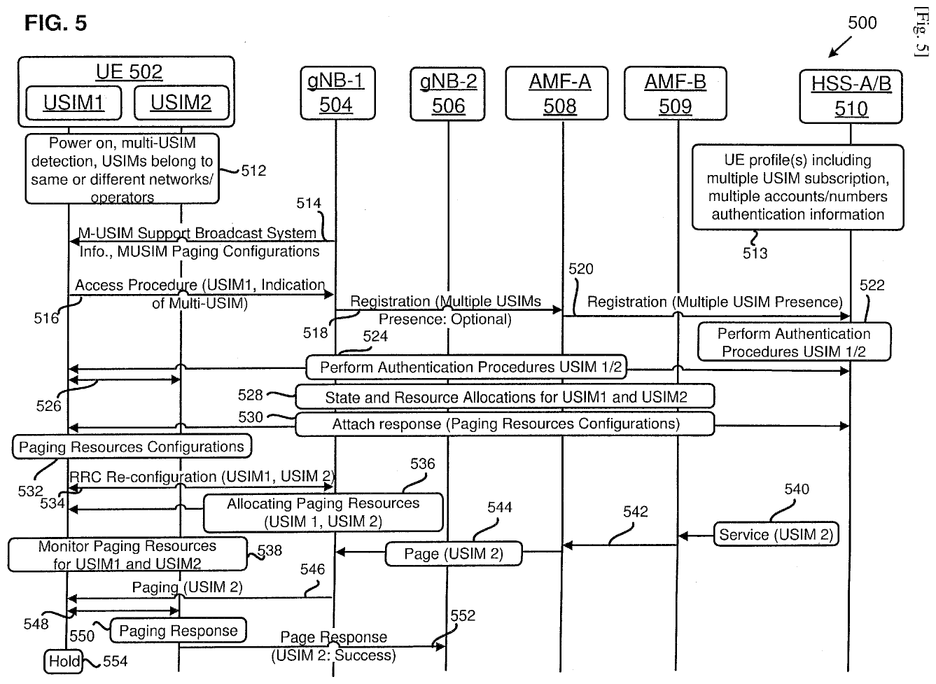

FIG. 5 is a signaling sequence diagram for schematically illustrating a method of registering the presence of multi-USIM based operations in a UE and capabilities of the multi-USIM based operations belonging to same or different wireless communication networks, and paging the multi-USIM based operation UE based on paging resource configurations from the networks, in accordance with example implementations of the present disclosure.

In the present implementation, as shown in diagram 500 of FIG. 5, UE 502 may report or register the presence and capabilities of multi-USIM based operations to AMF-A 508 and HSS-A/B 510 respectively through gNB-1 504 and gNB-2 506, for example, through one or more of actions 512, 513, 514, 516, 518, 520, 522, 524, 526, 528, 530, 532, 534, 536, 538, 540, 542, 544, 546, 548, 550, 552, and 554. In one implementation, UE 502 described in diagram 500 may correspond to multi-USIM UE 102 in FIG. 1 and/or multi-USIM UE 302 in FIG. 3. It should be noted that, in diagram 500, although UE 502 is shown to include two USIM based operations (USIM1 and USIM2 based operations), UE 502 may include and support more than two USIM based operations.

In action 512, UE 502 may be powered on. For example, UE 502 is turned on by a user. UE 502 may detect a presence of multiple USIMs, and multi-USIM based operations. For example, when UE 502 is powered on, UE 502 (e.g., through multi-USIM processor 122 and USIM manager 134 in FIG. 1) may detect the presence of more than one USIM. In the present implementation, before UE 502 is powered on, USIM1 and USIM2 are inserted into the USIM card slots of UE 502, for example. Thus, upon being powered on, UE 502 detects the presence of both USIM and USIM2 based operations. UE 502 may further determine if USIM1 and USIM2 based operations belong to same or different networks/operators (e.g., gNB-1 504 and gNB-2 506 in FIG. 5). In one implementation, UE 502 may check the operator IDs (e.g., PLMN IDs) associated with USIM1 and USIM2 based operations to determine if the operator IDs are different. For example, each operator ID may include a mobile country code (MCC) and a mobile network code (MNC). When the MCC and MNC of USIM1 based operations do not match those of USIM2 based operations, then UE 502 determines that USIM1 based operations and USIM2 based operations respectively belong to different networks/operators (e.g., gNB-1 504 (first PLMN) and gNB-2 506 (second PLMN)). In another implementation, UE 502 may check the operator IDs (e.g., PLMN IDs) associated with USIM1 and USIM2 based operations to determine if the operator IDs are same. For example, each operator ID may include a mobile country code (MCC) and a mobile network code (MNC). When the MCC and MNC of USIM1 based operations match those of USIM2 based operations, then UE 502 determines that USIM1 based operations and USIM2 based operations respectively belong to the same network/operator (e.g., PLMN).

In action 513, HSS-A/B 510 may store UE profiles including multi-USIM subscriptions, multiple accounts/numbers authentication information for one or more UEs.

In action 514, gNB-1 504 may send a Multi-USIM (M-USIM) paging configuration message to USIM1 of UE 502. The M-USIM paging configuration message may contain a block allocated for common paging resources for the MUSIM UE 502 to reduce the time necessary for UE 502 to scan and find individual paging resources based on its ID. In one implementation, the M-USIM paging configuration message may be included in M-USIM support broadcast system information.

In action 516, UE 502 may initiate an access procedure with gNB-1 504 using USIM1. In the access procedure, UE 502 may send a message to gNB-1 504 using USIM1, the associated RF circuitry (e.g., RF1 in FIG. 1), and the current access network system of USIM1. The message may include an indication indicating the presence of USIM1 and USIM2 in UE 502, and USIM2 related information (e.g., phone number, IMSI, IMEI, TMSI, etc.). The message may also include updated capabilities of USIM1.

In action 518, gNB-1 504 may send a registration message to AMF-A 508, for example, to register USIM1 of UE 502. The message may optionally include the multi-USIM presence of USIM1 and USIM2.

In action 520, AMF-A 508 may send the registration message having the multi-USIM presence of USIM1 and USIM2 to HSS-A/B 510 through the registration procedure.

In action 522, HSS-A/B 510 may initiate authentication procedures for USIM1 and optionally USIM2.

In action 524, HSS-A/B 510 and UE 502 may perform the authentication procedures for USIM1 and optionally for USIM2 via the USIM1 based operations.

In action 526, USIM2 may communicate with USIM1 (e.g., through USIM manager 134 in FIG. 1) to inform each other that both USIM1 that USIM2 are successfully authenticated and registered with their respective gNB-1 504 and gNB-2 506.

In action 528, gNB-1 504, gNB-2 506, AMF-A 508, and AMF-B 509 may communicate to determine the state and resource allocations for USIM1 and USIM2.

In action 530, HSS-A/B 510 may send an attachment response to USIM1 of UE 502 in an attachment procedure. In one implementation, the response may include additional information regarding UE 502 including IDs that can be used to determine paging resources in gNB-1 504 and gNB-2 506, and/or additional information regarding the common paging resources for MUSIM UE 502. During the attachment procedure, UE 502 may be in an RRC connected state with gNB-1 504. After the attachment procedure, UE 502 may reconfigure the RRC state to adjust for any anticipated traffic.

In action 532, USIM1 and USIM2 may communicate with each other to determine the paging resource configurations for their respective gNB-1 504 and gNB-2 506.

In action 534, USIM1 of UE 502 may request gNB-1 504 to reconfigure paging resources for USIM1 and USIM2 via an RRC reconfiguration message if information in the paging resource configurations of the attachment response is not sufficient or not present, or for any other reasons (e.g., the paging resources are invalid or expired, or during a handover).

In action 536, gNB-1 504 may reconfigure and/or reallocate paging resources for USIM1 and USIM2 upon receiving the RRC reconfiguration message.

In action 538, UE 502 may monitor paging resources (e.g., channels) for USIM1 and USIM2 using the common paging resources on gNB-1 504 or may determine if a different block in the attachment procedure is allocated to UE 502. In one implementation, UE 502 may monitor the paging channel dedicated to USIM1 and the common paging channel for USIM2 paging. In another implementation, UE 502 may switch between USIM1 and USIM2 and utilized the shared RF circuitry to monitor their assigned paging resources based on the paging resource configurations.

In action 540, AMF-B 509 may receive a service request for USIM2.

In action 542, AMF-B 509 may forward the service request for USIM2 to AMF-A 508.

In action 544, AMF-A 508 may send a paging message regarding the service request for USIM2 to gNB-1 504.

In action 546, gNB-1 504 may forward the paging message regarding the service request for USIM2 to USIM1.

In action 548, USIM1 may forward the paging message regarding the service request to USIM2.

In action 550, USIM2 may initiate a paging response to reply the service request for USIM2 by preparing an air interface to gNB-2 506. In one implementation, UE 502 may establish a new RRC connection with gNB-2 506 if no RRC connection has already been established with gNB-2 506. In one implementation, if there is an RRC connection between USIM1 and its serving base station or network (e.g., with gNB-1 504), UE 502 may put the active RRC connection on hold while USIM 2 prepares a paging response for the service request to its serving base station or network (e.g., with gNB-2 506).

In action 552, USIM2 may send the page response to gNB-2 506, which confirms or denies the service request with gNB-2 506.

In action 554, UE 502, upon forwarding the page regarding the service request to USIM2, may put the active service between USIM1 and gNB-1 504 on hold. In one implementation, UE 502, upon receiving the paging message for USIM2, may decline the service request for USIM2 and continue with the service between USIM1 and gNB-1 504.

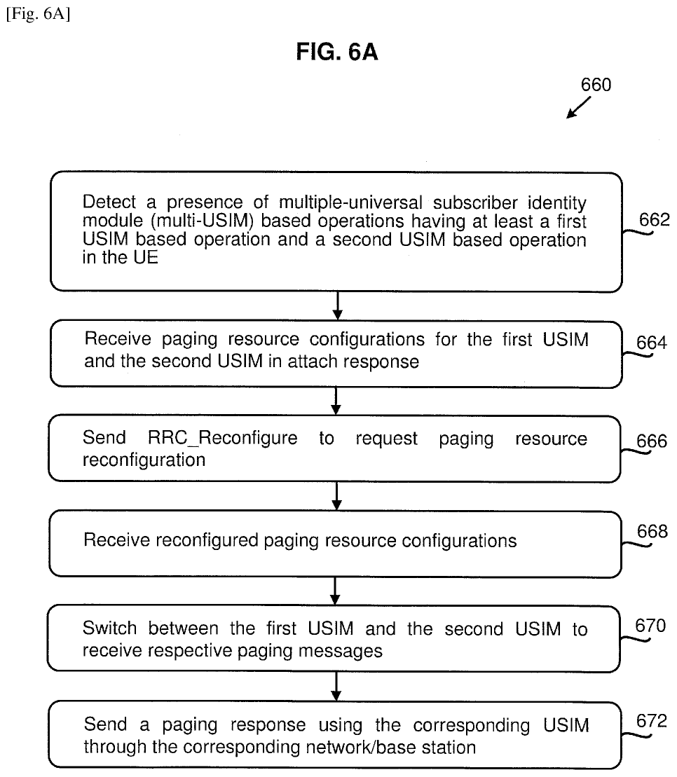

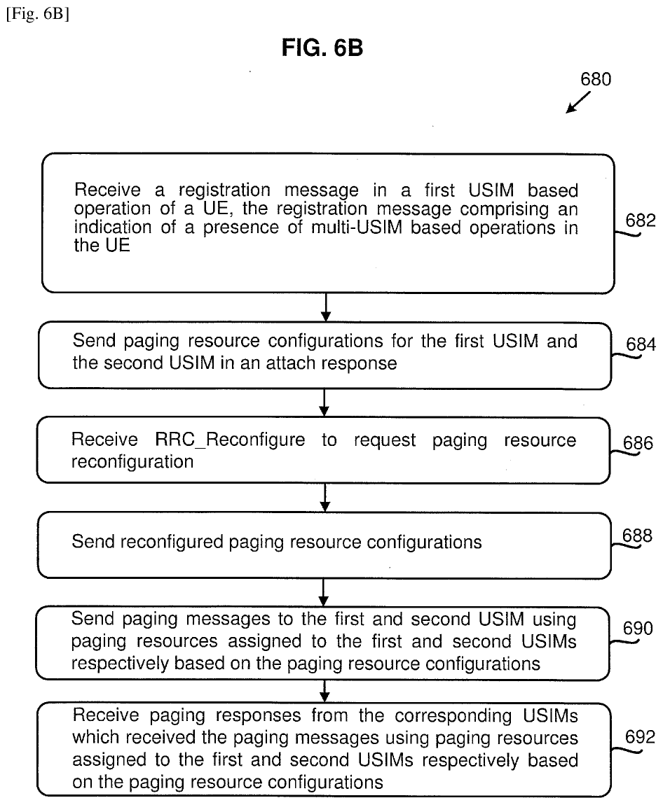

FIG. 6A is a flowchart diagram illustrating a method of a multi-USIM based operation UE for multi-USIM registrations in multiple wireless communication networks and receiving paging based on paging resource configurations from the networks, in accordance with example implementations of the present disclosure. As illustrated in FIG. 6A, flowchart 660 may include actions 662, 664, 666, 668, 670, and 672. In the present implementation, the UE may correspond to UE 502 supporting multi-USIM based operations in FIG. 5. Actions 662, 664, 666, 668, 670, and 672 will be discussed with reference to FIG. 5 below.

In action 662, the UE may detect a presence of multiple USIM based operations in the UE. With reference to FIG. 5, before UE 502 is powered on, USIM1 and USIM2 are inserted into the USIM card slots of UE 502, for example. When UE 502 is powered on, UE 502 (e.g., through multi-USIM processor 122 and USIM manager 134 in FIG. 1) may detect the presence of USIM1 and USIM2 based operations (e.g., action 512 in FIG. 5). UE 502 may further determine whether USIM1 and USIM2 based operations belong to the same or different networks/operators, for example, by comparing the operator IDs (e.g., PLMN IDs) of USIM1 and USIM2 based operations (e.g., action 512 in FIG. 5).

In action 664, the UE may receive paging resource configurations for the first USIM and the second USIM in an attach response. The paging resource configurations may include paging resource allocations for one or more USIMs of the UE. For example, in FIG. 5, USIM1 of UE 502 may receive an attach response in an attachment procedure from HSS-A/B 510 in action 530. In one implementation, the response may include additional information regarding UE 502 including IDs that can be used to determine paging resources in gNB-1 504 and gNB-2 506, and/or additional information regarding the common paging resources for M-USIM UE 502. During the attachment procedure, UE 502 may be in an RRC connected state with gNB-1 504. At the end of the attachment procedure, UE 502 may reconfigure its RRC state to adjust for any anticipated traffic.

In action 666, UE may send an RRC reconfiguration message to request for paging resource reconfigurations. For example, with reference to FIG. 5, UE 502 may send an RRC reconfiguration message to gNB-1 504 to request for paging resource reconfigurations in action 534. In one implementation, action 666 may be optional.

In action 668, UE may receive reconfigured paging resource configurations to UE. For example, in action 536, UE 502 may receive reconfigured paging resource configurations from gNB-1 504. The reconfigured paging resource configurations may include paging resources for USIM1 and USIM 2. In one implementation, action 668 may be optional.

In action 670, UE may switch between first USIM and second USIM to receive respective paging messages. For example, the UE 502 may switch between USIM1 and USIM2 and utilized the shared RF circuitry to monitor their assigned paging resources based on the paging resource configurations.

In action 672, UE may send a paging response using the corresponding USIM through the corresponding base station and network. For example, UE 502 may send a paging response to gNB-2 506 through USIM2.

In another implementation, the UE may receive paging for a second USIM through the first USIM, and send a paging response to an associated base station through the second USIM, as depicted in FIG. 5.

FIG. 6B is a flowchart diagram illustrating a method of a plurality of wireless communication networks for registering a multi-USIM based operation UE and providing paging based on paging resource configurations to the multi-USIM based operation UE, in accordance with example implementations of the present disclosure. As illustrated in FIG. 6B, flowchart 680 may include actions 682, 684, 686, 688, 690, and 692. In the present implementation, the UE may correspond to UE 502 supporting multi-USIM based operations in FIG. 5. In the present implementation, the network may include, but is not limited to, gNB-1 504, gNB-2 506, AMF-A 508, AMF-B 509, and HSS-A/B 510 in FIG. 5. Actions 682, 684, 686, 688, 690, and 692 will be discussed with reference to FIG. 5 below.

In action 682, the network may receive a registration message in a first MUSIM based operation of the UE, where the registration message includes an indication of the presence of MUSIM based operations in the UE. For example, in FIG. 5, after UE 502 determines that USIM1 and USIM2 based operations belong to same or different networks/operators, gNB-1 504 may receive a registration message from USIM1 in action 516.

In action 684, the network may send paging resource configurations for the first USIM and the second USIM in an attach response. For example, in action 530 of FIG. 5, HSS-A/B 510 may send an attach response in an attachment procedure to USIM1 of UE 502.

In action 686, the network may receive an RRC reconfiguration message from UE requesting for paging resource reconfigurations. For example, with reference to FIG. 5, gNB-1 504 may receive an RRC reconfiguration message from UE 502 requesting for paging resource reconfigurations in action 534. In one implementation, action 686 may be optional.

In action 688, the network may send reconfigured paging resource configurations to UE. For example, in action 536, gNB-1 504 may send reconfigured paging resource configurations to UE 502. The reconfigured paging resource configurations may include paging resources for USIM1 and USIM2. In one implementation, action 688 may be optional.

In action 690, the network may send paging messages to the first USIM and the second USIM using paging resources assigned to the first and second USIMs respectively based on the paging resource configurations.

In action 692, the network may receive paging responses from the corresponding USIMs which received the paging messages using paging resources assigned to the first and second USIMs respectively based on the paging resource configurations.

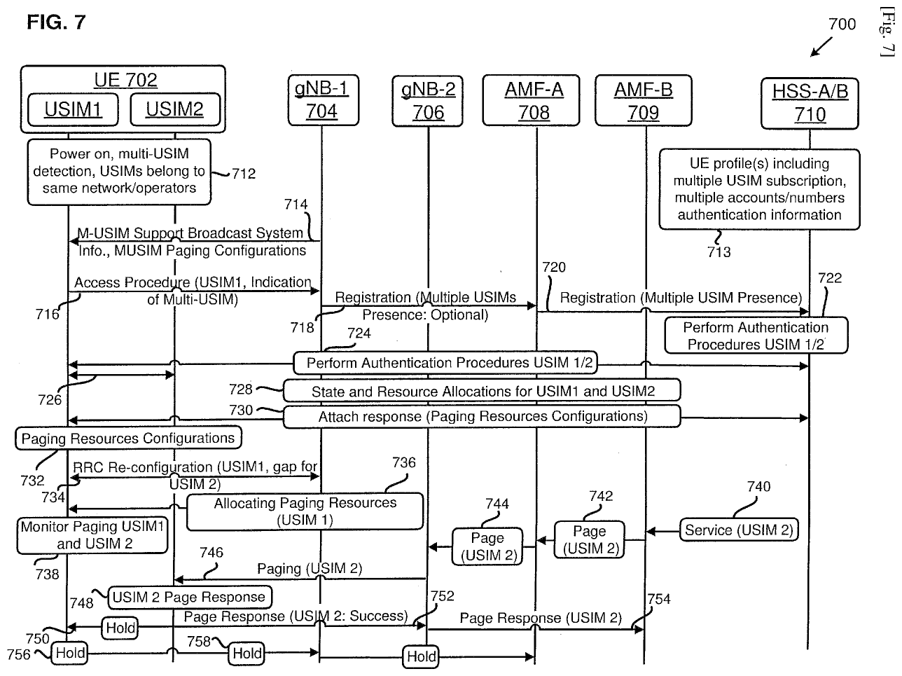

FIG. 7 is a signaling sequence diagram for schematically illustrating a method of registering the presence of multi-USIM based operations in a UE and capabilities of the multi-USIM based operations belonging to different wireless communication networks, and paging the multi-USIM based operation UE based on paging resource configurations from the networks, in accordance with example implementations of the present disclosure.

In the present implementation, as shown in FIG. 7, in diagram 700, UE 702 may report or register the presence and capabilities of multi-USIM based operations to AMF-A 708, AMF-B 709 and HSS-A/B 710 through gNB-1 704 and gNB-2 706, respectively, for example, using one or more of actions 712, 713, 714, 716, 718, 720, 722, 724, 726, 728, 730, 732, 734, 736, 738, 740, 742, 744, 746, 748, 750, 752, 754, 756, and 758. In one implementation, UE 702 described in diagram 700 may correspond to multi-USIM UE 102 in FIG. 1, multi-USIM UE 302 in FIG. 3, and/or multi-USIM UE 502 in FIG. 5.

In the present implementation, actions 712, 713, 714, 716, 718, 720, 722, 724, 726, 728, 730, and 732 of diagram 700 may be substantially similar to actions 512, 513, 514, 516, 518, 520, 522, 524, 526, 528, 530, and 532 of diagram 500, respectively, thus, the details of which are omitted for brevity.

In action 734, USIM1 of UE 702 may request gNB-1 704 to reconfigure paging resources for USIM1 and USIM2 via an RRC reconfiguration message if information in the paging resource configurations of the attachment response is not sufficient or not present, or for any other reasons (e.g., the paging resources are invalid or expired, or during a handover). In one implementation, in a case where no common paging resources for M-USIM is allocated, UE 702 may monitor paging channel on gNB-2 706 rather than gNB-1 704.

In the RRC-Reconfiguration message, gNB-1 704 may indicate information of one or more operation gaps (e.g., gap intervals during which USIM1 based operations need not monitor paging from gNB-A 704) for monitoring paging messages for USIM2 based operations with gNB-B 706. UE 702 may switch to USIM2 based operations to monitor paging messages from gNB-B 706 during one or more scheduled operation gaps (e.g., gap intervals) associated with USIM1 based operations.

In action 736, gNB-1 704 may allocate paging resources for USIM1 to UE 702.

In action 738, UE 502 may monitor paging resources (e.g., channels) for USIM1 and USIM2 using the common paging resources on gNB-1 704 or may determine if a different block in the attachment procedure is allocated to UE 702. In one implementation, UE 702 may monitor the paging channel dedicated to USIM1 and the common paging channel for USIM2 paging. In another implementation, UE 702 may switch between USIM1 and USIM2 and utilized the shared RF circuitry to monitor paging messages based on the paging resource configurations.

In action 740, AMF-B 709 may receive a service request for USIM2.

In action 742, AMF-B 709 may send a paging message for USIM2 to AMF-A 708. In one implementation, AMF-B 709 receives the service request for USIM2 and determines that UE 702 is reachable via AMF-A 708. AMF-B 709 then forwards a service request notifications to AMF-A 708 to page UE 702 under the coverage/service of gNB-1 704 which belongs to AMF-A 708. The UE 702 receives the page and then tunes to gNB-2 706 under the coverage/service AMF-B 709.

In action 744, AMF-A 708 may send the paging message regarding the service request for USIM2 to gNB-2 706.

In action 746, gNB-2 706 may forward the paging message regarding the service request to USIM2.

In action 748, USIM2 may initiate a paging response to reply the service request for USIM2 by preparing an air interface to gNB-2 706. In one implementation, UE 702 may establish a new RRC connection with gNB-2 706 if no RRC connection has already been established with gNB-2 706.

In action 750, USIM 2 may send request to USIM 2 to put an active service between USIM1 and gNB-1 704 on hold.

In action 752, USIM2 may send the paging response to gNB-2 706, which confirms or denies the service request with gNB-2 706.

In action 754, gNB-2 706 may send the paging response to AMF-B 709.

In action 756, USIM1 may put the active service with gNB-1 704 on hold.

In action 758, gNB-1 704 may put the service with AMF-A 708 on hold.

According to the above methods illustrated in FIGS. 3 (along with FIGS. 4A and 4B), 5 (along with FIGS. 6A and 6B), and 7, the System may indicate support of multi-USIM capabilities, Multi-USIM paging capabilities, and ability to simultaneously maintain connections to multiple networks. The UE may receive paging from secondary network while actively operating in current network. The paging may indicate the source network and the priority of the call. The network allocates paging resources that can be used for both networks. The network may also allocate separate resources for each network. The network may inform the UE with the paging configuration during the initial attachment stage. The UE may re-configure the paging resources at the serving network by sending an RRC Reconfiguration message with M-USIM paging indication, and be able to tune in to the current serving network or the second serving network to receive these resources configurations. The UE may be able to switch network at the particular paging time to check for page on the second system. Alternatively, the UE may receive a page notification on the current serving network (i.e., coordinated service) that a page is being sent over the second system/network. The UE is able to maintain RRC and CN state while moving from one system to the other.

The above methods also the network to activate any special features/services/messaging associated with the multi-USIM capable UEs. The UE may report its multiple U-SIM capabilities, presence of two or more USIMs, and capabilities of simultaneous connections to the networks, and indicate its network preference/priority list for the delivery of page notifications in case of coordinated connection.

The Network and UE may be able to maintain RRC and CN state while moving from one system to the other. The UE may be able to terminate/suspend the service on the primary network while operating on the secondary network.

The above methods also allow the delivery of a paging message destined to one USIM, while the UE is actively communicating with another USIM on a different network system. The above methods also allow the network to handle mobile-terminated data or control-plane activity occurrence on a suspended connection requested by the UE. Thus, paging collisions occurring in the UE among active multiple USIM based operations can be avoided. The methods allow a multi-USIM multi-network/operator supported UE to handle emergency calls and sessions. As such, the network and the UE can maintain RRC and CN state while moving from one system to another substantially without any interruption to either sessions/services. In addition, the above methods allow the handling of service prioritization and specifying the UE behavior upon reception of paging information based on USIM configuration and/or user preferences.

In one example, a user equipment (UE) for wireless communication, the UE comprising: one or more non-transitory computer-readable media having computer-executable instructions embodied thereon; at least one processor coupled to the one or more non-transitory computer-readable media and configured to execute the computer-executable instructions to: detect a presence of multiple-universal subscriber identity module (multi-USIM) based operations having at least a first USIM based operation and a second USIM based operation in the UE; receive paging resource configurations for the first USIM and the second USIM; monitor at least one paging resource channel indicated in the paging resource configurations for receiving paging for at least one of the first USIM and the second USIM.

In one example, the UE, wherein the paging resource configurations are received through an attach response message.

In one example, the UE, wherein the paging resource configurations are received through a System Information broadcast channel message.

In one example, the UE, wherein the paging resource configurations indicate a location of a common paging resource channel for multi-USIM devices operating within a network.

In one example, the UE, wherein the paging resource configurations indicate at least one of a first location of a first dedicated paging resource channel of a first network associated with the first USIM, and a second location of a second dedicated paging resource channel of a second network associated with the second USIM.

In one example, the UE, wherein the at least one processor is further configured to execute the computer-executable instructions to: receive a paging message for at least one of the first USIM and the second USIM through a common paging resource channel indicated by the paging resource configurations.

In one example, the UE, wherein the at least one processor is further configured to execute the computer-executable instructions to: receive a paging message for at least one of the first USIM and the second USIM through a dedicated paging resource channel indicated by the paging resource configurations.

In one example, the UE, wherein the at least one processor is further configured to execute the computer-executable instructions to: receive a paging message for the second USIM by the first USIM through a dedicated paging resource channel of a first network associated with the first USIM, the dedicated paging resource channel being indicated by the paging resource configurations.

In one example, the UE, wherein the at least one processor is further configured to execute the computer-executable instructions to: forward the paging message for the second USIM from the first USIM to the second USIM; and send a paging response message using the second USIM to a second network associated with the second USIM.

In one example, the UE, wherein the at least one processor is further configured to execute the computer-executable instructions to: place an active call on the first USIM on hold before sending the paging response message to the second network using the second USIM.

In one example, the UE, wherein the at least one processor is further configured to execute the computer-executable instructions to: send a radio resource control (RRC)_Reconfiguration message to a serving network to reconfigure paging resources for at least one of the first USIM and the second USIM.

In one example, the UE, wherein the at least one processor is further configured to execute the computer-executable instructions to: receive from the serving network reconfigured paging resource configurations for at least one of the first USIM and the second USIM; and monitor at least one reconfigured paging resource channel indicated in the reconfigured paging resource configurations for receiving paging for at least one of the first USIM and the second USIM.

In one example, the UE, wherein the at least one processor is further configured to execute the computer-executable instructions to: switch between a first network associated with the first USIM and a second network associated with the second USIM to monitor corresponding dedicated paging resource channels for the first USIM and the second USIM based on the paging resource configurations.

In one example, the UE, wherein the at least one processor is further configured to execute the computer-executable instructions to: switch from a first network associated with the first USIM to a second network associated with the second USIM to monitor paging for the second USIM during gap periods indicated in the paging resource configurations.

In one example, the UE, wherein a first network associated with the first USIM and a second network associated with the second USIM belong to a same Public Land Mobile Network (PLMN).

In one example, a method of a user equipment (UE), the method comprising: detecting a presence of multi-multiple-universal subscriber identity module (multi-USIM) based operations having at least a first USIM based operation and a second USIM based operation in the UE; receiving paging resource configurations for the first USIM and the second USIM; monitoring at least one paging resource channel indicated in the paging resource configurations for receiving paging for at least one of the first USIM and the second USIM.

In one example, the method, wherein the paging resource configurations are received through an attach response message.

In one example, the method, wherein the paging resource configurations are received through a System Information broadcast channel message.

In one example, the method, wherein the paging resource configurations indicate a location of a common paging resource channel for multi-USIM devices operating within a network.

In one example, the method, wherein the paging resource configurations indicate at least one of a first location of a first dedicated paging resource channel of a first network associated with the first USIM, and a second location of a second dedicated paging resource channel of a second network associated with the second USIM.

In one example, the method, further comprising: receiving a paging message for at least one of the first USIM and the second USIM through a common paging resource channel indicated by the paging resource configurations.

In one example, the method, further comprising: receiving a paging message for at least one of the first USIM and the second USIM through a dedicated paging resource channel indicated by the paging resource configurations.

In one example, the method, further comprising: receiving a paging message for the second USIM by the first USIM through a dedicated paging resource channel of a first network associated with the first USIM, the dedicated paging resource channel being indicated by the paging resource configurations.

In one example, the method, further comprising: forwarding the paging message for the second USIM from the first USIM to the second USIM; and sending a paging response message using the second USIM to a second network associated with the second USIM.

In one example, the method, further comprising: placing an active call on the first USIM on hold before sending the paging response message to the second network using the second USIM.

In one example, the method, wherein further comprising: sending a radio resource control (RRC)_Reconfiguration message to a serving network to reconfigure paging resources for at least one of the first USIM and the second USIM.

In one example, the method, further comprising: receiving, from the serving network, reconfigured paging resource configurations for at least one of the first USIM and the second USIM; and monitoring at least one reconfigured paging resource channel indicated in the reconfigured paging resource configurations for receiving paging for at least one of the first USIM and the second USIM.

In one example, the method, further comprising: switching between a first network associated with the first USIM and a second network associated with the second USIM to monitor corresponding dedicated paging resource channels for the first USIM and the second USIM based on the paging resource configurations.

In one example, the method, further comprising: switching from a first network associated with the first USIM to a second network associated with the second USIM to monitor paging for the second USIM during gap periods indicated in the paging resource configurations.

In one example, the method, wherein a first network associated with the first USIM and a second network associated with the second USIM belong to a same Public Land Mobile Network (PLMN).

In one example, a communication network comprising: a Public Land Mobile Network (PLMN) configured to: receive a first registration message in a first multiple-universal subscriber identity module (USIM) based operation of a user equipment (UE), the first registration message comprising an indication of a presence of multi-USIM based operations in the UE; send paging resource configurations to the UE; wherein the paging resource configurations comprise at least one paging resource channel for paging at least one of a first USIM and a second USIM of the UE.

In one example, the method, wherein the PLMN is configured to send the paging resource configurations through an attach response message through a first base station associated with the first USIM to the UE.

In one example, the method, wherein the PLMN is configured to send the paging resource configurations through a System Information broadcast channel message through a first base station associated with the first USIM to the UE.

In one example, the method, wherein the paging resource configurations indicate a location of a common paging resource channel for multi-USIM devices operating under the PLMN.

In one example, the method, wherein the paging resource configurations indicate at least one of a first location of a first dedicated paging resource channel of a first network associated with the first USIM, and a second location of a second dedicated paging resource channel of a second network associated with the second USIM.

In one example, the method, wherein a first base station associated with the first USIM of the UE under the PLMN is configured to send a paging message for at least one of the first USIM and the second USIM through a common paging resource channel indicated by the paging resource configurations.

In one example, the method, wherein a first base station associated with the first USIM of the UE under the PLMN is configured to send a paging message for at least one of the first USIM and the second USIM through a dedicated paging resource channel indicated by the paging resource configurations.

In one example, the method, wherein a first base station associated with the first USIM of the UE under the PLMN is configured to send a paging message for the second USIM to the first USIM through a dedicated paging resource channel of a first network associated with the first USIM, the dedicated paging resource channel being indicated by the paging resource configurations.

In one example, the method, wherein a second base station associated with the second USIM of the UE under the PLMN is configured to receive a paging response from the UE through the second USIM and a second network associated with the second USIM.

In one example, the method, wherein an active call on the first USIM is placed on hold before the second base station receives the paging response from the UE through the second USIM and the second network.

In one example, the method, wherein a first base station associated with the first USIM of the UE under the PLMN is configured to receive a radio resource control (RRC)_Reconfiguration message from the UE, the RRC_Reconfiguration message requesting the PLMN to reconfigure paging resources for at least one of the first USIM and the second USIM.

In one example, the method, wherein: the first base station is configured to send reconfigured paging resource configurations for at least one of the first USIM and the second USIM to the UE; wherein the reconfigured paging resource configurations comprise at least one reconfigured paging resource channel for paging at least one of the first USIM and the second USIM.

In one example, the method, wherein the UE is configured to switch between a first network associated with the first USIM and a second network associated with the second USIM to monitor corresponding dedicated paging resource channels for the first USIM and the second USIM based on the paging resource configurations.

In one example, the method, wherein the UE is configured to switch from a first network associated with the first USIM to a second network associated with the second USIM to monitor paging for the second USIM during gap periods indicated in the paging resource configurations.

In one example, the method, wherein the first network and the second network belong to the PLMN.

In one example, a method of a communication network, the method comprising: receiving, by a Public Land Mobile Network (PLMN), a first registration message in a first multiple-universal subscriber identity module (USIM) based operation of a user equipment (UE), the first registration message comprising an indication of a presence of multi-USIM based operations in the UE; sending, by the PLMN, paging resource configurations to the UE; wherein the paging resource configurations comprise at least one paging resource channel for paging at least one of a first USIM and a second USIM of the UE.

In one example, the method, further comprising: sending, by the PLMN, the paging resource configurations through an attach response message through a first base station associated with the first USIM to the UE.

In one example, the method, further comprising: sending, by the PLMN the paging resource configurations through a System Information broadcast channel message through a first base station associated with the first USIM to the UE.

In one example, the method, wherein the paging resource configurations indicate a location of a common paging resource channel for multi-USIM devices operating under the PLMN.

In one example, the method, wherein the paging resource configurations indicate at least one of a first location of a first dedicated paging resource channel of a first network associated with the first USIM, and a second location of a second dedicated paging resource channel of a second network associated with the second USIM.

In one example, the method, further comprising: sending, by a first base station associated with the first USIM of the UE under the PLMN, a paging message for at least one of the first USIM and the second USIM through a common paging resource channel indicated by the paging resource configurations.

In one example, the method, further comprising: sending, by a first base station associated with the first USIM of the UE under the PLMN, a paging message for at least one of the first USIM and the second USIM through a dedicated paging resource channel indicated by the paging resource configurations.

In one example, the method, further comprising: sending, by a first base station associated with the first USIM of the UE under the PLMN, a paging message for the second USIM to the first USIM through a dedicated paging resource channel of a first network associated with the first USIM, the dedicated paging resource channel being indicated by the paging resource configurations.

In one example, the method, further comprising: receiving, by a second base station associated with the second USIM of the UE under the PLMN, a paging response from the UE through the second USIM and a second network associated with the second USIM.

In one example, the method, wherein an active call on the first USIM is placed on hold before the second base station receives the paging response from the UE through the second USIM and the second network.

In one example, the method, further comprising: Receiving, by a first base station associated with the first USIM of the UE under the PLMN, a radio resource control (RRC)_Reconfiguration message from the UE, the RRC_Reconfiguration message requesting the PLMN to reconfigure paging resources for at least one of the first USIM and the second USIM.

In one example, the method, further comprising: sending, by the first base station, reconfigured paging resource configurations for at least one of the first USIM and the second USIM to the UE; wherein the reconfigured paging resource configurations comprise at least one reconfigured paging resource channel for paging at least one of the first USIM and the second USIM.

In one example, the method, further comprising: switching, by the UE, between a first network associated with the first USIM and a second network associated with the second USIM to monitor corresponding dedicated paging resource channels for the first USIM and the second USIM based on the paging resource configurations.

In one example, the method, further comprising: switching, by the UE, from a first network associated with the first USIM to a second network associated with the second USIM to monitor paging for the second USIM during gap periods indicated in the paging resource configurations.

In one example, the method, wherein the first network and the second network belong to the PLMN.

What is claimed is:

1. A user equipment (UE) for wireless communication, the UE comprising:
one or more non-transitory computer-readable media having computer-executable instructions embodied thereon;
at least one processor coupled to the one or more non-transitory computer-readable media and configured to execute the computer-executable instructions to:
detect a presence of multiple-universal subscriber identity module (multi-USIM) based operations having at least a first USIM based operation and a second USIM based operation in the UE;
receive paging resource configurations for the first USIM and the second USIM;
monitor at least one paging resource channel indicated in the paging resource configurations for receiving paging for at least one of the first USIM and the second USIM.

2. The UE of claim 1, wherein the paging resource configurations are received through an attach response message.

3. The UE of claim 1, wherein the paging resource configurations are received through a System Information broadcast channel message.

4. The UE of claim 1, wherein the paging resource configurations indicate a location of a common paging resource channel for multi-USIM devices operating within a network.

5. The UE of claim 1, wherein the paging resource configurations indicate at least one of a first location of a first dedicated paging resource channel of a first network associated with the first USIM, and a second location of a second dedicated paging resource channel of a second network associated with the second USIM.

6. The UE of claim 1, wherein the at least one processor is further configured to execute the computer-executable instructions to:
receive a paging message for at least one of the first USIM and the second USIM through a common paging resource channel indicated by the paging resource configurations.

7. The UE of claim 1, wherein the at least one processor is further configured to execute the computer-executable instructions to:
receive a paging message for at least one of the first USIM and the second USIM through a dedicated paging resource channel indicated by the paging resource configurations.

8. The UE of claim 1, wherein the at least one processor is further configured to execute the computer-executable instructions to:
receive a paging message for the second USIM by the first USIM through a dedicated paging resource channel of a first network associated with the first USIM, the dedicated paging resource channel being indicated by the paging resource configurations.

9. The UE of claim 8, wherein the at least one processor is further configured to execute the computer-executable instructions to:
forward the paging message for the second USIM from the first USIM to the second USIM; and
send a paging response message using the second USIM to a second network associated with the second USIM.

10-18. (canceled)

19. A communication network comprising:
a Public Land Mobile Network (PLMN) configured to:
receive a first registration message in a first multiple-universal subscriber identity module (USIM) based operation of a user equipment (UE), the first registration message comprising an indication of
a presence of multi-USIM based operations in the UE;
send paging resource configurations to the UE;
wherein the paging resource configurations comprise at least one paging resource channel for paging at least one of a first USIM and a second USIM of the UE.

20. A method of a communication network, the method comprising:
receiving, by a Public Land Mobile Network (PLMN), a first registration message in a first multiple-universal subscriber identity module (USIM) based operation of a user equipment (UE), the first registration message comprising an indication of a presence of multi-USIM based operations in the UE;
sending, by the PLMN, paging resource configurations to the UE;
wherein the paging resource configurations comprise at least one paging resource channel for paging at least one of a first USIM and a second USIM of the UE.
